(19) United States
(12) Patent Application Publication
(10) Pub. No.: US 2007/0169682 A1
(43) Pub. Date: Jul. 26, 2007

(54) WRIST FLAG DEVICE

(76) Inventor: Randy Boyd, Milwaukee, WI (US)

Correspondence Address: Moss & Barnett P.A., 4800 Wells Fargo Center, 90 South Seventh Street, Minneapolis, MN, 55402-4129, US

(21) Appl. No.: 11/695,403

(22) Filed: Apr. 2, 2007

Related U.S. Application Data
(63) Continuation-in-part of application No. 11/336,676, filed on Jan. 20, 2006.

(51) Int. Cl. G09F 17/00

(52) U.S. Cl. 116/173

(57) ABSTRACT

A flag connected to a wristband or similar device by a length of material. The wristband and the length of material permit a spectator to throw the flag in a direction away from the spectator without fear of it being lost. The length of material permits the spectator to easily retrieve the flag after it is thrown. The ability to throw the flag increases its visibility and can be used to indicate to a game official a missed infraction. The length of material also allows the spectator to spin the flag around to show the spectator's admiration for the team or game. The flag and length of material are storable in a pocket attached to the wristband.

### CLAIM OF PRIORITY

This application is a Continuation-in-Part application of Ser. No. 11/336,676 filed on Jan. 20, 2006 which is incorporated herein in its reference.

### BACKGROUND OF THE INVENTION

1. Field of the Invention

The example embodiment(s) of the invention described herein relate to the field of toys and/or novelty items and particularly pertain to a flag attached to a wrist band by a length of material for utilization during a sporting event.

2. Description of the Related Art

The use of flags at sporting events and the like is readily known. These flags are often handed out to spectators entering a stadium or ballpark. The flags usually have team names and logos fashioned thereon or other types of advertisement for sponsors. During games it is not uncommon for the spectators in the excitement of the moment to throw the flag in the air. Unfortunately, due to the physical characteristics of the flag it is all too common that a spectator is unable to retrieve the flag once it is thrown. This can be particularly troublesome years later when the spectator learns that the flag has become a collector's item.

One inventor, Gregory Mathews, the applicant of U.S. Pat. No. 4,850,052 attempted to resolve this problem. Mathews invented a glove that has a pocket for holding a flag or piece of cloth. During the game a spectator removes a portion of the cloth from the pocket and attaches it to fasteners disposed on the finger tips of the glove. In this fashion the cloth is spread out over the palm of the glove. The spectator can then use their hand to indicate a rule infraction that may or may not have been missed by a game official. Several shortcomings of the device disclosed by Mathews are readily apparent. For instance, in the summer the spectator's hand will sweat making wearing the glove uncomfortable. In the winter the glove may not provide enough warmth to keep the spectator's hand warm if the game is conducted outdoors. Additionally, the glove can hinder a spectator's ability to retrieve items from a pocket or purse to purchase food or memorabilia. Lastly, a significant shortcoming of the Mathews device is that the flag is kept close to the spectator's hand thereby limiting the ability of a game official of seeing it.

Woolery, the applicant of U.S. Pat. No. 1,670,176 invented a signal that consisted of a flag attached to a glove or partial glove for signaling while driving a vehicle. The Woolery device has the same shortcomings as the Mathews, increased heat in the summer; not enough warmth in the winter; and a flag that is kept too close to the user's hand.

What is needed is a flag that can be thrown a distance away from the spectator and easily retrieved. What is also needed is a flag that it is easily visible to the referees, athletes and other spectators. Another unfulfilled need is a flag that is comfortable to wear and permits free movement of the spectator. All of these and other needs are fulfilled by the present invention and will become readily apparent upon examination of the brief summary of the invention, drawings and detailed description.

### BRIEF SUMMARY OF THE INVENTION

The invention pertains to a flag or sheet of material fashioned as a flag that is connected to a wristband or similar device by a length of material. The wristband and the length of material permit a spectator to throw the flag in a direction away from the spectator without fear of it being lost. In one example embodiment, an attachment member is disposed between and connected to the length of material and the flag such that the user can select one of a plurality of flags to use. Additionally, it permits a spectator to use multiple flags. In one embodiment of the invention, the wristband can include a pocket, pouch, or other type of storage device for storing the flag(s) and the length of material when the flag is not being used.

An advantage of the invention over the prior art is that it can be thrown a distance away from the spectator thereby increasing its visibility.

Another advantage of the invention is that permits the spectator to be more involved in the game. For instance, if the spectator believes there was an infraction that was not seen or called by an official, the spectator can throw the flag into the air as should have been done by the official. This allows the spectator to demonstrate their frustration toward the official.

Another advantage of the invention is that the flag can be spun around above the spectator to show the participants of the game their admiration. Since the flag is attached to the length of material there is no fear that it may be lost.

Still another advantage of the invention is that the flag and length of material can be stored on the user's wrist while traveling to and/or from the event.

These and other advantages of the invention will become more fully apparent from the following brief description of the drawings, detailed description of the invention and the appended claims.

### BRIEF DESCRIPTION OF THE DRAWINGS

FIG. 1 is a perspective view of one embodiment of the wrist flag device.

FIG. 2 is a perspective view of one embodiment of the wristband of the wrist flag device.

FIG. 3 is a perspective view of one embodiment of the flag of the wrist flag device

FIG. 4 is a perspective view of one embodiment of the flag of the wrist flag device.

FIG. 5 is a front view of one embodiment of the flag of the wrist flag device dispose in a pocket of the wristband.

FIG. 6 is a front view of one embodiment of the flag of the wrist flag device having a length of material attached in a pocket of the wristband.

The preceding figures are for illustrative purposes only. Therefore, they should not be considered limiting but rather samples of example embodiments of the invention.

### DETAILED DESCRIPTION OF THE INVENTION

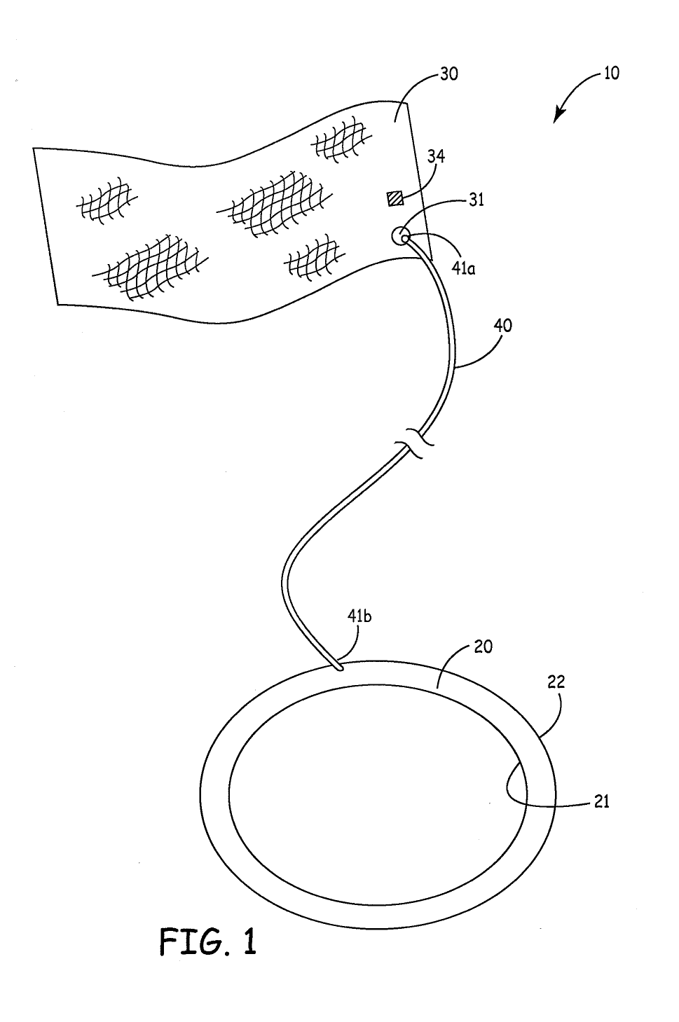

Referring to appended example FIGS. 1-4, an embodiment of a wrist flag device is indicated by numeral 10. In an example embodiment, the device 10 includes a wristband 20 and a flag or sheet of material 30 connected together by a length of material or tether 40.

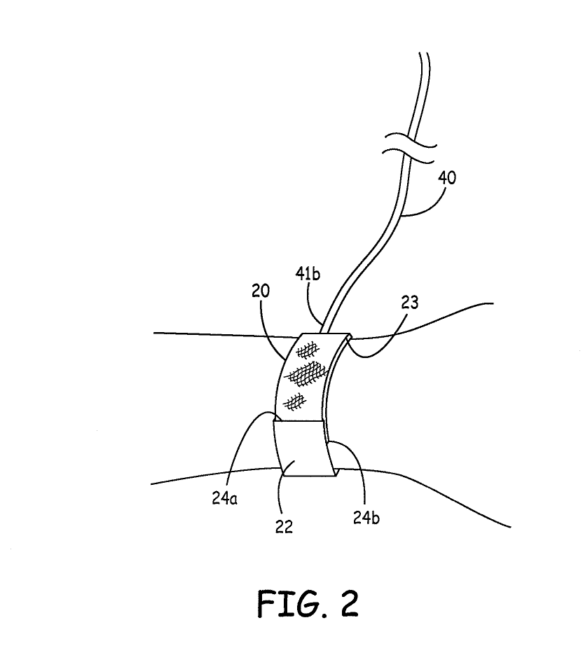

Referring to FIGS. 1 and 2, wristband 20 includes a sheet of material such as nylon webbing and the like having opposed first 21 and second 22 surfaces with the first opposed surface 21 being disposable adjacent a spectator's wrist. The wristband 20 can include a fastening mechanism 23 such as snaps, hook and loop fasteners, and the like that are readily known to those skilled in the art. In one example embodiment, wristband 20 includes two opposed ends indicated by numerals 24a and 24b of FIG. 2. The use of the fastening mechanism 23 in conjunction with the opposed ends 24a and 24b permit wristband 20 to be adjustable about a wrist of a spectator.

In another embodiment, wristband 20 can comprise a solid strip of material that can be manufactured from an elastomeric material. This embodiment permits a spectator to stretch the wristband 20 over their hand and onto their wrist. In yet another embodiment of the invention, wristband 20 can comprise a solid or generally rigid ring that fits over the spectator's hand and wrist. Other embodiments and modifications are possible and should be considered to be within the spirit and scope of the invention. The placement of the wristband 20 can also be varied such as being placed on a spectator's forearm or upper arm. The wristband 20 can also be attached to a spectator's article of clothing such as a belt, jacket, pants, shirts, and the like.

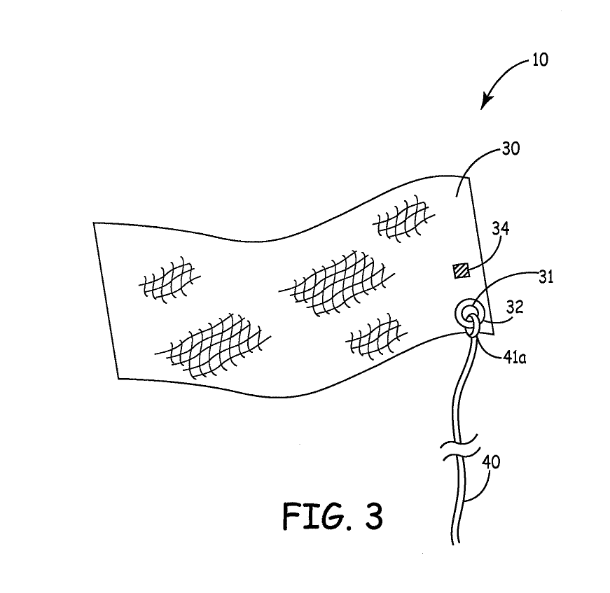

Referring to FIGS. 1 and 3, flag 30 can comprise any type of sheet material such as nylon, cotton, synthetic blends and the like. In one example embodiment, a hole 31 is formed in a lower corner of flag 30 for receiving and securing at least a portion of tether 40 therein. Although illustrated in a corner of the flag 30, the hole 31 can be disposed through any portion of the flag 30. Additionally, other types of attachment mechanisms are also possible such as hook and loop fasteners, snap fasteners, rings and the like. Any fastener capable of attaching the flag 30 to the tether 40 should be considered to be within the spirit and scope of the invention.

Referring particularly to FIG. 3, a reinforcement ring 32 can be attached to the hole 31 to prevent damage to the flag 30 from attachment to tether 40. The reinforcement ring 32 can be manufactured from plastic, foam, metal, or the like so long as it reinforces the material of the flag 30 bordering or forming the hole 31.

Referring to FIGS. 1, 3 and 4, a fastening member 34 can be attached, coupled, connected to and the like to a portion of the flag 30 to fasten the flag 30 to a portion of the wristband 20. The fastening member 34 can comprise one half of a hook and loop fastener, half of a snap fastener, or any other type of fastener. The other half of the fastening member 34 can be secured to the wristband 20 or any other portion of the device. In one embodiment, one half of the fastener 34 can be connected an article of clothing of the spectator for securing the flag 30 thereto. In the embodiment having a wristband 20, comprised of a cooperating hooks and loops, the fastening member 34 can be removably coupled to a portion of the wristband 20 until it is to be used by the spectator. This prevents the flag from interfering with the movement of the spectator.

The flag 30 can be manufactured in any shape, size, and color. In one example embodiment, advertisements, team logos and the like can be disposed on the flag 30 by any means. In one of the preferred embodiments the flag 30 is manufactured from a yellow material similar to that of officials of sporting events.

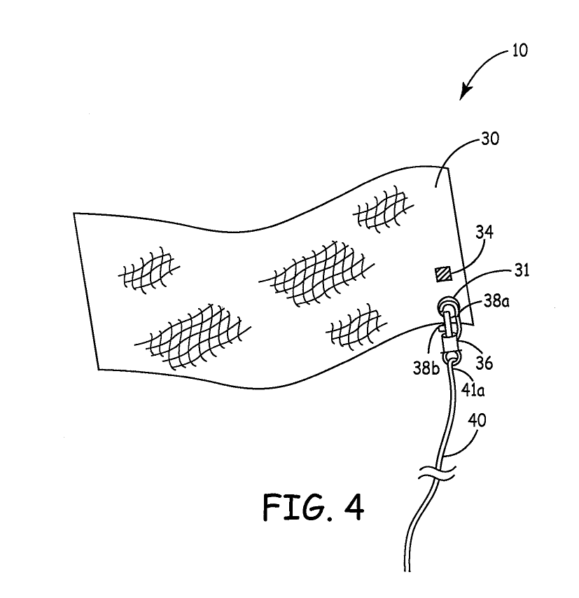

Referring now to FIG. 4, an attachment member 36 can be operatively coupled between the flag 30 and the tether 40. The attachment member 36 can comprise a hook 38a and a retractable or pivotable post 38b operatively coupled together to permit a spectator to replace, change, interchange, and the like different flags 30. In one embodiment, the hook 38a is extendable through the hole 31 and the post 38b is allow to engage the hook 38a and prevent its detachment from the flag 30.

The attachment member 36 can be manufacture from any material such as plastic, foam, or any compressible material. In one embodiment, the attachment member can be manufactured from or coated with a foam material such that it will not damage or harm anything that it comes into contact with during use. For the true sport enthusiast, the attachment member 36 allows the spectator to change flags 30 depending upon the event they are attending or watching on the television. Flags 30 can be manufactured for any games such as, football, basketball, or hockey. Flags 30 can also be manufactured for all levels of sports including high school, college and professional leagues or associations. Other events are also possible and should be considered to be within the spirit and scope of the invention.

The tether 40 connecting the wristband 20 and the 30 flag preferably has a length that permits the spectator to throw the flag 30 into the air and easily retrieve it. It can be manufactured from any material such as rope, twine, cord, an elastic band, and the like. In one embodiment of the invention, the tether 40 can be detached from either or both of the flag 30 and the wristband 20 such that it can be replaced. Cooperative hook and loop fasteners can be used to hook ends 41a and 41b of the tether 40 to the flag 30 and the wristband 20 respectively. Other types of fasteners can also be used to removably secure or attach the tether 40 to the flag 30 and/or wristband 20.

In one embodiment, the tether 40 can be manufactured to have the same color or material as the flag 30. It is possible to have tethers 40 that are decorative and/or include logos, advertisements and the like. Other embodiment and modifications are also possible and should be considered to be within the spirit and scope of the invention.

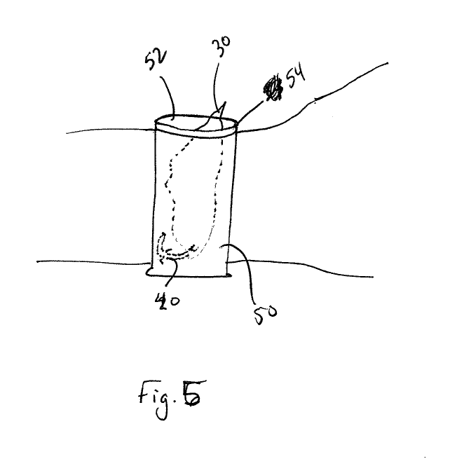

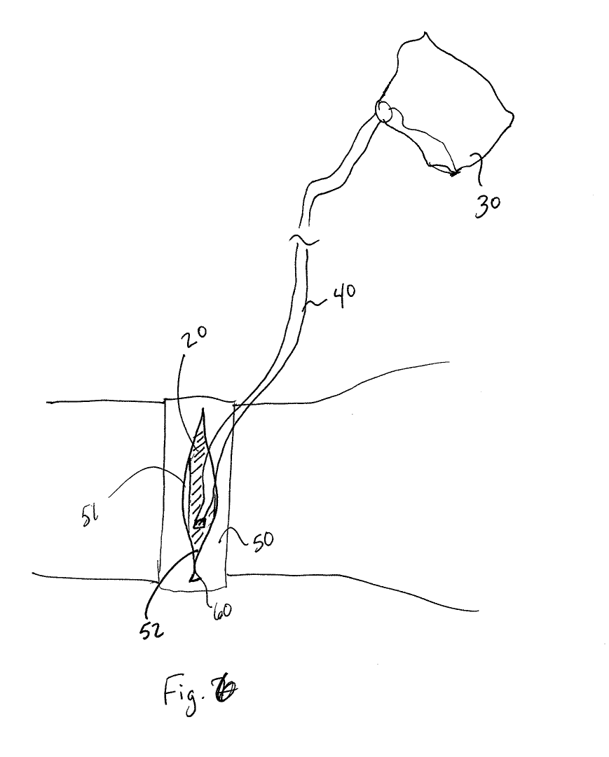

Referring to FIGS. 5 and 6, a sheet of material can be attached, fixed or formed to the wristband 20 to create a pocket or pouch 50 for storing the flag 30 and the tether 40. The pocket 50 can include an opening 52 for providing access to an interior 53 of the pocket 50. In one embodiment, as illustrated in FIG. 5, the opening 52 can be disposed generally in an end 54 of the pocket 52. In another embodiment, as illustrated in FIG. 6, the opening 52 can be disposed generally along at least a portion of a length of the pocket 50.

As illustrated in FIG. 6, the tether 40 can be attached to a portion of the pocket 50. In one embodiment, the tether 40 can be attached to an inner surface of the pocket 50 or to an outer surface of the pocket 50. The tether 40 can also be attached to a portion of the wristband 20 which can extend through the pocket 50 or to any other point on the pocket 50. Half of the fastening member 34 can be attached to the flag 30, while the other half of the fastening member 34 can be attached to a portion of the pocket 50. The fastening member 34 permits a spectator to secure the flag 30 to a portion of the pocket 50 for temporary storage during a spectator event.

The pocket 50 can also include a closure mechanism 60 to close the opening 52. The closure mechanism 60 can include a zipper, hook and loop fastener, male and female snap portions, and the like. The closure mechanism 60 permits a spectator to secure the flag 30 and the tether 40 in the interior 51 of the pocket 50 while traveling to and from spectator events and during storage.

Similar to the flag 30 and the tether 40, the flag 50 can include logos, advertisements and/or other indicia. All of the indicia on the flag 30, tether 40 and pocket 50 can be the same or they can vary, such that the flag 30 and pocket 50 can include indicia identifying an athletic team, while the tether 40 includes indicia identifying an advertisement. Any combination of indicia is possible and should be considered to be within the spirit and scope of the invention.

In use a spectator places the wristband 20 around their wrist. Whenever the spectator is motivated he or she may throw the flag 30 into the air. The spectator can retrieve the flag 30 by lifting their arm or pulling on the tether 40. The user may throw the flag 30 into the air to draw the official's attention to a missed infraction during a game. The spectator can also spin or twirl the flag 30 in the air above them while holding the tether 40. This may be done to demonstrate the spectator's appreciation of an event during the game such as a touchdown, basket, homerun or a goal.

When not in use the spectator can place the flag 30 and tether 40 into the interior 51 of the pocket 50. The user can then close the closure mechanism 60 to prevent the flag 30 and tether 40 from falling out of the pocket 50. In another embodiment, the spectator can store multiple flags 30 in the pocket 50 for different spectator events and the like. Other uses for the device 10 are also possible and modifications in use should be considered to be within the spirit and scope of the invention.

What is claimed is:

1. A wrist flag device for a wrist of user, the device comprising:
a wrist attachment having opposed surfaces, wherein at least one of the opposed surfaces is disposable against a portion of the user;
a pocket formed on the wrist attachment;
a tether having a first end attached to a portion of the wrist attachment; and
at least one flag disposed to a second end of the tether, wherein a user is able to store the flag and the tether in the pocket.

2. The device of claim 1, wherein the wrist attachment comprises a web material adjustable to the wrist of the user.

3. The device of claim 1, wherein the wrist attachment has a first end and a second end, wherein the first and second ends are cooperatively connectable.

4. The device of claim 1, wherein a hole extends through a portion of the flag for receiving and securing a portion of the tether.

5. The device of claim 4 further comprising a ring dispose about the hole to reinforce the flag.

6. The device of claim 1 further comprising an attachment member operatively coupled between the flag and the tether.

7. The device of claim 6, wherein the attachment member includes a hook portion and a post portion, wherein the hook and post portions are operatively engaged with each other to prevent detachment with the flag.

8. The device of claim 7 further comprising a ring attached about the hole of the flag to engage the attachment member.

9. A wrist flag device for a user, the device comprising:
a sheet capable of being tossed into the air by a user;
a storage means capable of be secured to a user for storing the sheet;
a securing means disposed between the sheet and the storage means for securing the sheet, wherein a user is able to toss the sheet into the air and retrieve it by using the securing means.

10. The device of claim 9, wherein the securing means is storable in the storage means.

11. The device of claim 9 further comprising an attachment means operatively disposed between the sheet and the securing means to permit a user to remove the sheet from the securing means.

12. The device of claim 11, wherein the attachment means includes a first portion attached to the sheet and a second portion attached to the securing means, wherein the first and second portions are operatively engaged with each other to prevent detachment of the sheet from the securing means.

13. The device of claim 9 further comprising a closing means being disposed on the storage means to enclose the sheet and the securing means within the storage means.

14. The device of claim 9 further includes an adjustment means securable to at least a portion of the storage means to adjust its attachment to a portion of a user.

15. The device of claim 9 further comprising indicia being disposed on the sheet.

16. The device of claim 9 further comprising indicia being disposed on the storage means.

17. The device of claim 9 further comprising indicia being disposed on the securing means.

18. A method of indicating an infraction during an event using the wrist flag device of claim 1, the method comprising the steps of:
attaching a wrist attachment to a wrist of a user;
holding onto at least a portion of a flag secured to the wrist attachment by a tether; and
throwing the flag into the air when an infraction is observed.

19. The method of claim 18 further comprising the step of storing the flag and tether in a pocket attached to the wrist attachment

20. The method of claim 18 further comprising the step twirling the flag in the air with the tether to show approval during an event.
